(19) United States
(12) Patent Application Publication
(10) Pub. No.: US 2022/0098899 A1
(43) Pub. Date: Mar. 31, 2022

(54) ELECTRIC DOOR LOCK FACILITY

(71) Applicant: Gianni Industries Inc., Taipei (TW)

(72) Inventor: Chih Chung Chang, Taipei (TW)

(21) Appl. No.: 17/034,762

(22) Filed: Sep. 28, 2020

(51) Int. Cl. E05B 47/00; E05B 47/02

(52) U.S. Cl. CPC E05B 47/0001; E05B 2047/0016; E05B 2047/0037; E05B 47/023

(57) ABSTRACT

A door lock facility includes a tongue pivotally attached to a housing with a pivot pin, an elbow is rotatably attached to the housing and includes a limb engageable with and detachable from an inner end portion of the tongue, an anchor is rotatably attached to the housing and includes one end portion located close to the tongue for anchoring a free end portion of the limb between the anchor and the tongue, a follower is slidably engaged in an actuator and movable into and out of the actuator for moving the anchor toward and away from the limb, and the actuator includes a rod slidably engaged in the actuator and moveable out of the actuator in order to rotate the elbow relative to the housing and to move the limb of the elbow from the tongue.

### BACKGROUND OF THE INVENTION

### 1. Field of the Invention

The present invention relates to a door lock facility, and more particularly to an electric door lock facility including a safety structure or mechanism for allowing the electric door lock facility to be suitably and safely operated or actuated and for preventing the electric door lock facility from being stuck or jammed.

### 2. Description of the Prior Art

Various kinds of typical electromagnetic lock devices, such as electric dropbolts, cathode locks or the like have been developed and provided for conducting or operating or locking and unlocking various door devices, and normally comprise a core or deadbolt actuatable or movable or operatable with a coil or an electromagnetic mechanism to actuate the deadbolt or tongue and to lock or unlock a door or window or the like.

For example, U.S. Pat. No. 4,677,834 to Hicks, U.S. Pat. No. 5,511,832 to Kiinzel, U.S. Pat. No. 5,531,086 to Bryant, U.S. Pat. No. 5,566,991 to Young, U.S. Pat. No. 5,799,518 to Du, U.S. Pat. No. 5,934,720 to Karalius, U.S. Pat. No. 6,079,755 to Chang, U.S. Pat. No. 6,302,455 to Huang, U.S. Pat. No. 7,014,226 to Huang, and U.S. Pat. No. 7,237,412 to Huang disclose several of the typical electromagnetic deadbolt lock devices each also comprising a deadbolt or tongue indirectly coupled to an electromagnetic mechanism with a connecting rod for allowing the deadbolt or tongue to be actuated or operated by the electromagnetic mechanism.

However, after the door panel is locked with or by the typical electromagnetic deadbolt lock devices, the deadbolt or tongue may be contacted and forced onto the parts or elements of the electromagnetic deadbolt lock devices with a preload which may have the electromagnetic deadbolt lock devices be jammed such that the electromagnetic deadbolt lock devices may not be easily actuated or operated by the user.

The present invention has arisen to mitigate and/or obviate the afore-described disadvantages of the conventional electromagnetic lock devices.

### SUMMARY OF THE INVENTION

The primary objective of the present invention is to provide an electric door lock facility including a safety structure or mechanism for allowing the electric door lock facility to be suitably and safely operated or actuated and for preventing the electric door lock facility from being stuck or jammed.

In accordance with one aspect of the invention, there is provided a lock facility comprising a housing including a chamber formed in the housing, and including an opening formed in the housing and communicating with the chamber of the housing, a tongue pivotally attached to the housing with a pivot pin, the tongue including a first end portion engaged in the chamber and extendible out of the opening of the housing, and the tongue including a second end portion, an elbow rotatably attached to the housing with a pivot axle, the elbow including a limb engageable with and detachable from the second end portion of the tongue, and including a lever tilted relative to the limb, the elbow including a roller attached to the limb for smoothly engaging with the second end portion of the tongue, an anchor rotatably attached to the housing with a pivot shaft, the anchor including a first end portion located close to the tongue for selectively anchoring and retaining a free end portion of the limb between the first end portion of the anchor and the second end portion of the tongue, an actuator engaged in the housing, a follower slidably received and engaged in the actuator and movable into and out of the actuator for selectively attracting and moving the second end portion of the anchor toward the actuator and for selectively forcing and moving the first end portion of the anchor away from the free end portion of the limb, and the actuator includes a rod slidably received and engaged in the actuator and moveable out of the actuator, in order to rotate the elbow relative to the housing and to move the limb of the elbow from the second end portion of the tongue.

The actuator includes a casing engaged in the housing, and the follower is slidably received and engaged in the casing and movable into and out of the casing. The rod is slidably received and engaged in the follower and extendible out of the casing to engage with the lever of the elbow.

The actuator includes a spring biasing element engaged between the rod and the follower for biasing and moving the rod into the follower. The housing includes a spring biasing member engaged between the housing and the lever for biasing the elbow to rotate relative to the housing and for moving the limb of the elbow to engage with the second end portion of the tongue.

The housing includes a spring biasing element engaged between the housing and the tongue for biasing and moving the first end portion of the tongue into the opening of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of an electric door lock facility in accordance with the present invention for a door device;

FIG. 2 is a partial exploded view of the electric door lock facility;

FIG. 3 is a top plan schematic view illustrating the locking operation of the electric door lock facility; and

FIG. 4 is another top plan schematic view similar to FIG. 3, illustrating the unlocking operation of the electric door lock facility.

### DETAILED DESCRIPTION OF THE PREFERRED EMBODIMENT

An electric door lock facility in accordance with the present invention is developed and provided for attaching or mounting or securing to a door member or door panel of a door device (not illustrated), for locking and unlocking the door device, and the door panel or door member of the door device is worked in cooperate with a door element of the door device, such as a door frame (not illustrated) or the like. The door frame or door element of the door device includes a latch bolt (not illustrated) formed or provided or engaged therein for engaging with the electric door lock facility in accordance with the present invention.

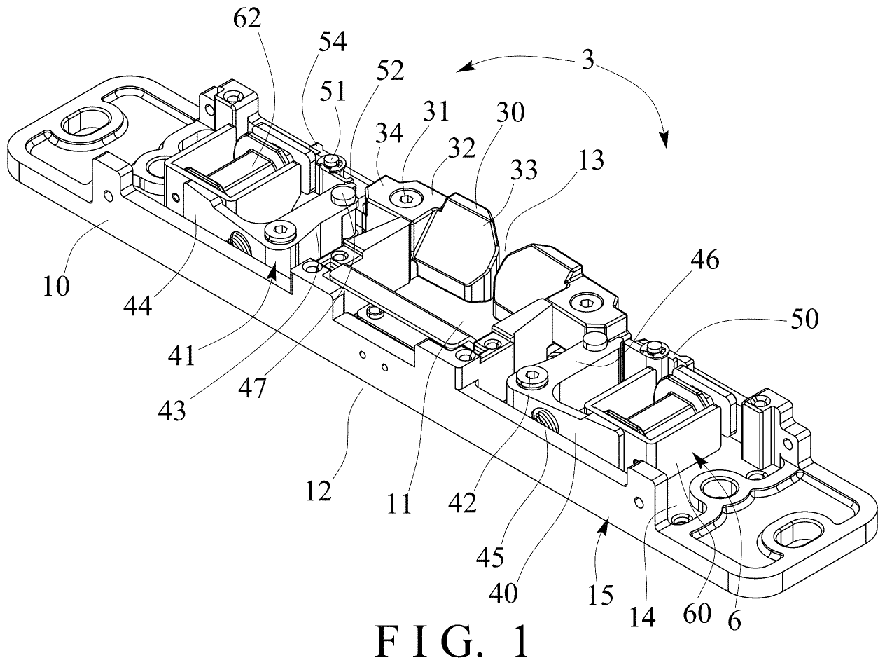

Referring to the drawings, and as shown in FIGS. 1-4, the electric door lock facility in accordance with the present invention comprises a housing 10 disposed or engaged into the door member or the door frame, and including a compartment or chamber 11 formed therein, such as formed in the middle or intermediate portion 12 thereof for receiving various parts or members or elements or the like therein, and including a notch or opening 13 formed therein, such as also formed in the middle or intermediate portion 12 thereof and communicating with the chamber 11 of the housing 10, and including one or more (such as two) chambers or compartments 14 formed in the two end or side portions 15 of the housing 10.

The electric door lock facility includes one or more (such as two) actuating or controlling devices 3 disposed or engaged into the housing 10 and disposed or arranged and spaced from each other and/or identical to each other, and/or disposed opposite to each other, and/or disposed anti-symmetric to each other, and one of the two identical controlling devices 3 will be disclosed in details hereinafter. For example, the controlling devices 3 each include a catch or tongue 30 having a screw or bolt or pivot axle or pivot pin 31 attached or mounted or secured to a middle or intermediate portion 32 thereof for pivotally or rotatably attaching or mounting or securing to the housing 10 with the pivot pin 31.

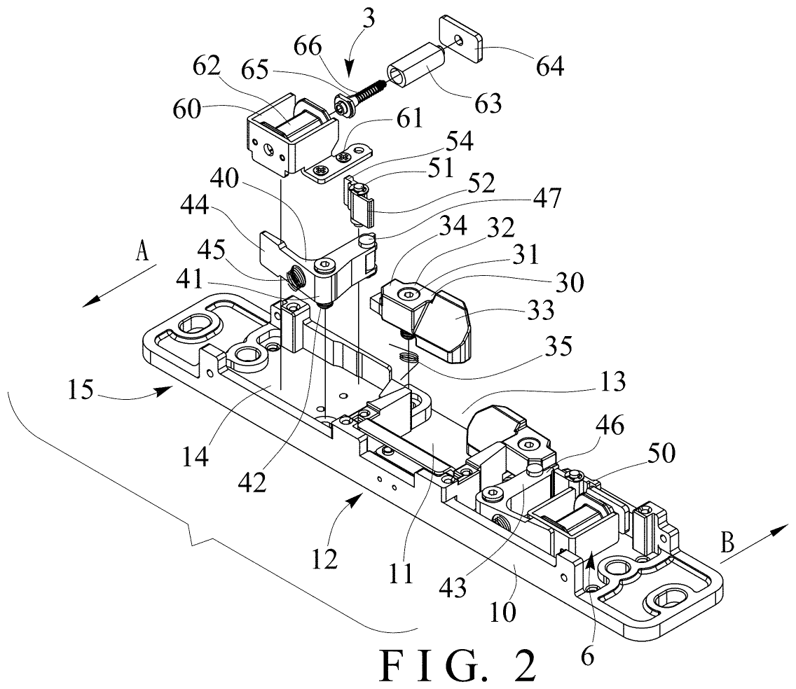

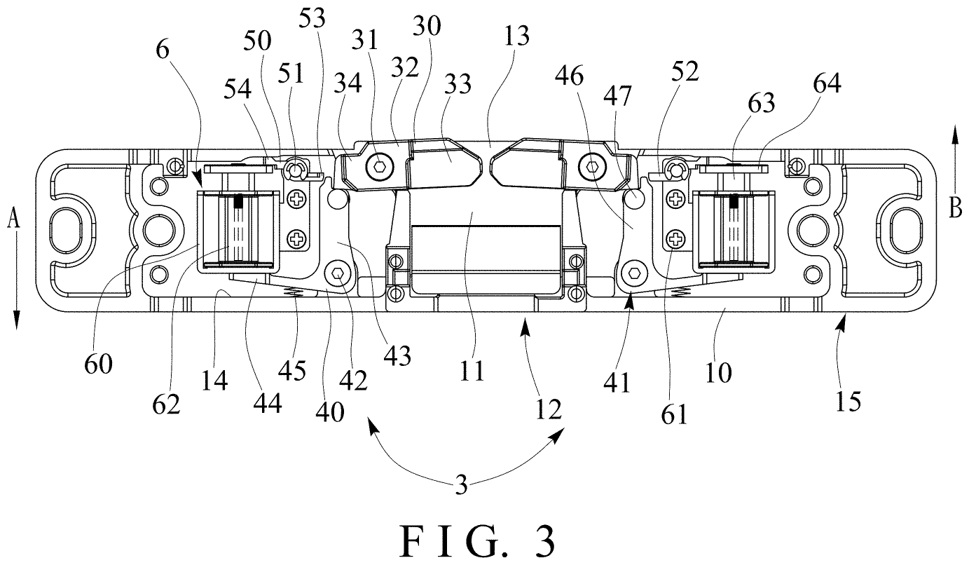

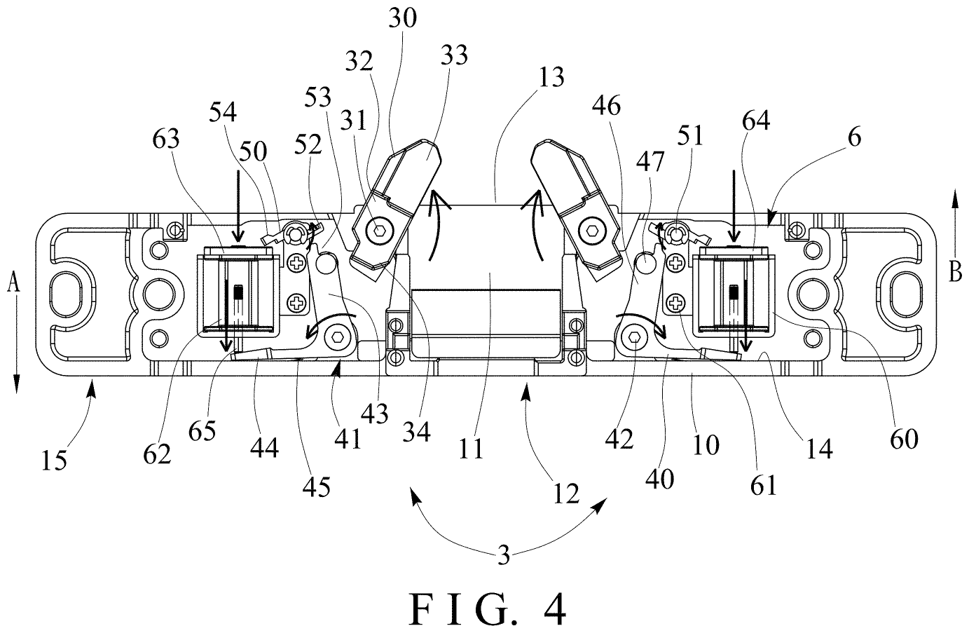

As shown in FIGS. 3 and 4, the tongue 30 includes one or outer or first end portion 33 disposed or engaged or located in the chamber 11 (FIGS. 1, 3) and extendible out of the opening 13 of the housing 10 (FIG. 4), and includes another or inner or second end portion 34 received or engaged in the compartment 14 of the housing 10. A spring biasing member or element 35 (FIG. 2) contacted or engaged with the housing 10 and the tongue 30 for biasing and forcing or moving the outer or first end portion 33 of the tongue 30 to engage into the opening 13 of the housing 10 (FIG. 3) and to engage with the latch bolt (not illustrated) that is engaged into the opening 13 of the housing 10, and thus for latching or locking the door panel and the door frame together.

The controlling device 3 further includes a follower or elbow 40 received or engaged in the compartment 14 of the housing 10 and having a middle or intermediate portion 41 pivotally or rotatably attached or mounted or secured to the housing 10 with another pivot pin or pivot axle 42 for allowing the elbow 40 to be pivoted or rotated relative to the housing 10. For example, the elbow 40 includes a leg or limb 43 engageable with (FIGS. 1, 3) or dis-engageable or detachable or separable from the inner or second end portion 34 of the tongue 30 (FIG. 4), another limb or lever 44 tilted or inclined or bent relative to the limb 43, and a spring biasing member 45 contacted or engaged with the housing 10 and the lever 44 for biasing and forcing or moving the elbow 40 to pivot or rotate relative to the housing 10 and for moving or actuating or operating the limb 43 of the elbow 40 to engage with the inner or second end portion 34 of the tongue 30 (FIG. 3) selectively.

The controlling device 3 further includes a limit piece or latch or anchor 50 also received or engaged in the compartment 14 of the housing 10 and having a middle or intermediate portion pivotally or rotatably attached or mounted or secured to the housing 10 with another pivot pin or pivot shaft 51 for allowing the anchor 50 to be pivoted or rotated relative to the housing 10. The anchor 50 is arranged substantially parallel to the lever 44 and/or substantially tilted or inclined or perpendicular to the limb 43 of the elbow 40, and includes a closer or first end portion 52 that is located closer to the tongue 30 for selectively anchoring or retaining or confining the free end portion 46 of the limb 43 between the closer or first end portion 52 of the anchor 50 and the inner or distal or second end portion 34 of the tongue 30 (FIG. 3) selectively. It is preferable that the elbow 40 includes a pulley or roller 47 attached or mounted or secured to the free end portion 46 of the limb 43 for smoothly engaging with the inner or second end portion 34 of the tongue 30.

It is to be noted that a little space or gap 53 will be formed between the closer or first end portion 52 of the anchor 50 and the free end portion 46 of the limb 43 for allowing the limb 43 of the elbow 40 to be slightly pivoted or rotated relative to the housing 10 when the free end portion 46 of the limb 43 is disposed or engaged or located between the closer or first end portion 52 of the anchor 50 and the inner or second end portion 34 of the tongue 30 (FIG. 3). The anchor 50 includes an outer or distal or second end portion 54 disposed or located distal to or farther away from the tongue 30, and the anchor 50 is made of metal or magnetically attractable materials.

The controlling device 3 further includes an actuating or driving device 6 having a receptacle or casing 60 received or engaged in the compartment 14 of the housing 10 and attached or mounted or secured to the housing 10 with one or more screws or bolts or catches or latches or fasteners 61 or the like, the driving device 6 includes an electromagnetic device or mechanism or solenoid or actuator 62 disposed or engaged or located within the casing 60, or the casing 60 is an outer receptacle of the actuator 62, a sliding member or mandrel or follower 63 is slidably received or engaged in the casing 60 and actuatable or movable or operatable with the actuator 62 for moving the follower 63 into (FIG. 4) or out of the casing 60, and a cap or bar 64 is attached or mounted or secured to the follower 63 and moved in concert with follower 63.

The bar 64 and/or the follower 63 is contactable or engageable with the distal or second end portion 54 of the anchor 50 for selectively attracting or forcing and moving the distal or second end portion 54 of the anchor 50 toward the casing 60 in the direction A (FIG. 4) with the actuator 62, and for selectively forcing and moving the closer or first end portion 52 of the anchor 50 away from the free end portion 46 of the limb 43. For example, when the actuator 62 is switched on, the distal or second end portion 54 of the anchor 50 may be selectively attracted or forced and moved toward the casing 60 in the direction A (FIG. 4) in order to space the closer or first end portion 52 of the anchor 50 from the free end portion 46 of the limb 43.

Alternatively, the distal or second end portion 54 of the anchor 50 may be selectively forced and moved toward the casing 60 when the actuator 62 is switched off. As shown in FIG. 4, when the closer or first end portion 52 of the anchor 50 is forced and moved away from the free end portion 46 of the limb 43, the limb 43 is allowed to pivot or rotate relative to the housing 10 freely for allowing the tongue 30 to be pivoted or rotated relative to the housing 10 freely at this moment. The driving device 6 further includes another sliding member or follower or core or rod 65 (FIGS. 2, 4) slidably received or engaged in the casing 60 and/or in the follower 63 and arranged for allowing the rod 65 to be selectively forced and moved out of the casing 60 with the actuator 62 when the actuator 62 is switched on, in order to pivot or rotate the elbow 40 relative to the housing 10 and so as to move or actuate or operate the limb 43 of the elbow 40 from the inner or second end portion 34 of the tongue 30 (FIG. 4) selectively. It is preferable that another spring biasing member or element 66 (FIG. 2) may further be provided and engaged onto the rod 65 and engaged between the rod 65 and the follower 63 for biasing and forcing or moving the rod 65 into the casing 60 and/or in the follower 63 (FIG. 3) when the actuator 62 is switched off.

In operation, as shown in FIG. 3, when the actuator 62 is switched off, the bar 64 and/or the follower 63 will be moved out of the casing 60 in the direction B and may force and move the closer or first end portion 52 of the anchor 50 toward the free end portion 46 of the limb 43 and the inner or distal or second end portion 34 of the tongue 30 in order to engage or locate the free end portion 46 of the limb 43 between the closer or first end portion 52 of the anchor 50 and the inner or second end portion 34 of the tongue 30, and so as to lock the tongue 30 and the latch bolt (not illustrated) in place.

It is to be noted that a little space or gap 53 is formed between the closer or first end portion 52 of the anchor 50 and the free end portion 46 of the limb 43 such that the limb 43 of the elbow 40 may be slightly pivoted or rotated relative to the housing 10 when the free end portion 46 of the limb 43 is disposed or engaged or located between the closer or first end portion 52 of the anchor 50 and the inner or second end portion 34 of the tongue 30, and such that the limb 43 of the elbow 40 has not been forced and positioned in place with a preload or the like.

On the contrary, as shown in FIG. 4, when the bar 64 and/or the follower 63 of the actuator 62 is actuated or operated or when the actuator 62 is switched on, the distal or second end portion 54 of the anchor 50 may be selectively attracted or forced and moved toward the casing 60 in order to space the closer or first end portion 52 of the anchor 50 from the free end portion 46 of the limb 43, at this moment, the free end portion 46 of the limb 43 is released and is allowed to pivot or rotate relative to the housing 10 freely for allowing the tongue 30 to be pivoted or rotated relative to the housing 10 freely.

Accordingly, the electric door lock facility in accordance with the present invention includes a safety structure or mechanism for allowing the electric door lock facility to be suitably and safely operated or actuated and for preventing the electric door lock facility from being stuck or jammed.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lock facility comprising:
a housing including a chamber formed in said housing, and including an opening formed in said housing and communicating with said chamber of said housing,
a tongue pivotally attached to said housing with a pivot pin, said tongue including a first end portion engaged in said chamber and extendible out of said opening of said housing, and said tongue including a second end portion,
an elbow rotatably attached to said housing with a pivot axle, said elbow including a limb engageable with and detachable from said second end portion of said tongue, and including a lever tilted relative to said limb, said elbow including a roller attached to said limb for engaging with said second end portion of said tongue,
an anchor rotatably attached to said housing with a pivot shaft, said anchor including a first end portion located close to said tongue for selectively anchoring and retaining a free end portion of said limb between said first end portion of said anchor and said second end portion of said tongue,
an actuator engaged in said housing, a follower slidably received and engaged in said actuator and movable into and out of said actuator for selectively attracting and moving said second end portion of said anchor toward said actuator and for selectively forcing and moving said first end portion of said anchor away from said free end portion of said limb, and
said actuator including a rod slidably received and engaged in said actuator and moveable out of said actuator, in order to rotate said elbow relative to said housing and to move said limb of said elbow from said second end portion of said tongue.

2. The lock facility as claimed in claim 1, wherein said actuator includes a casing engaged in said housing, and said follower is slidably received and engaged in said casing and movable into and out of said casing.

3. The lock facility as claimed in claim 2, wherein said rod is slidably received and engaged in said follower and extendible out of said casing to engage with said lever of said elbow.

4. The lock facility as claimed in claim 1, wherein said actuator includes a spring biasing element engaged between said rod and said follower for biasing and moving said rod into said follower.

5. The lock facility as claimed in claim 1, wherein said housing includes a spring biasing member engaged between said housing and said lever for biasing said elbow to rotate relative to said housing and for moving said limb of said elbow to engage with said second end portion of said tongue.

6. The lock facility as claimed in claim 1, wherein said housing includes a spring biasing element engaged between said housing and said tongue for biasing and moving said first end portion of said tongue into said opening of said housing.
